(19) United States
(12) Patent Application Publication
(10) Pub. No.: US 2002/0173924 A1
(43) Pub. Date: Nov. 21, 2002

(54) Online certification method with quality assurance

(75) Inventor: Hui Chuan Lin, Taipei (TW)

Correspondence Address: MERCHANT & GOULD PC, P.O. BOX 2903, MINNEAPOLIS, MN, 55402-0903, US

(73) Assignee: Mitac International Corp., Hsinchu (TW)

(21) Appl. No.: 10/137,154

(22) Filed: May 2, 2002

(30) Foreign Application Priority Data
May 18, 2001 (TW) 90111906

(51) Int. Cl. G06F 19/00; G01N 37/00

(52) U.S. Cl. 702/81

(57) ABSTRACT

An online certification method with quality assurance is disclosed. A trading web site uses EDI as a message transmission protocol to send information inside the company and to a vendor for notifying relevant units the operating procedures. This can effectively cut down the work flow of vendor and commodity online certifications.

### BACKGROUND OF THE INVENTION

1. Field of Invention

The invention relates to an online certification method with quality assurance and, in particular, to an online certification method with quality assurance for vendors and commodities.

2. Related Art

E-commerce and Internet has become an undefeatable trend. According to the development in the E-commerce and the Internet, we can divide the E-commerce into three parts: business to consumer (B2C), Intranet, and business to business (B2B).

If an enterprise wants to have a successful E-commerce, its business model has to be re-evaluated to find out where the E-commerce applies. The first thing to consider is to provide consumers more extra value services via the operation efficiency increase (e.g. speeding up order processes; shortening material distributions, growing sales, lifting consumer satisfaction, lowering stocking, and having a successful marketing strategy). The enterprise should also help its business partner grow and move up, middle, and down stream vendors toward E-commerce together.

The development and prevalence of the Internet force us to consider two big subjects about Enterprise Resource Planning (ERP) and Supply Chain Management (SCM) that are not products of the Internet technology.

For manufacturers, many certification procedures in the old BP (Business Process) are tedious and waste a lot of manpower and resources. The low efficiency does not only cause troubles for the purchase department, IRC department, research department, security and medical department and vendors, but also delay the best timing for buying commodities.

The BPR (Business Process Reengineer) is oriented in consumer demands emphasized by the current market to discuss and design the work flow structure inside the company. Afterwards, goals and company strategies are set up so that they are flow-oriented, thus defining the role played by each department and the interactions among the departments.

Therefore, pushing the BPR has to be based upon the E-business environment. It is desirable to provide an online certification method with quality assurance for vendors and commodities in order to increase the online trading efficiency in CC (Collaboration Commerce).

### SUMMARY OF THE INVENTION

The invention discloses an online certification method with quality assurance, providing an online certification work flow for vendors and commodities. The vendor online certification includes the steps of: registering vendors, performing a submission/check/examination procedure, notifying relevant department to come and check, each department performing examination, and posting/notifying examination results.

The online certification for commodities includes the steps of: checking an AVL (Authorized Vendor List) of ERP (Enterprise Resource Planning), requesting for vendor's samples/confirmations, a purchase department examining/registering a commodity examination application, testing (commodity evaluation report), registering a QVL (Qualified Vendor List), ECR (Engineering Change Require) holding a CCB (Change Control Board) conference, and the purchase department completing commodity certification according to the QVL of a second source.

An objective of the invention is to shorten the work flow of vendor and commodity online certification. Through a trading web site, message transmission agreements are sent to the company and the vendor through EDI, notifying relevant departments the work flow.

### BRIEF DESCRIPTION OF THE DRAWINGS

The invention will become more fully understood from the detailed description given hereinbelow illustration only, and thus are not limitative of the present invention, and wherein:

FIG. 1 is a BP (business process) diagram of the disclosed vendor certification; and

FIG. 2 is a BP (business process) diagram of the disclosed commodity certification.

### DETAILED DESCRIPTION OF THE INVENTION

The invention provides an online certification method with quality assurance. Through a trading web site, messages are transmitted to a company and vendors using EDI as the data transmission protocol, notifying relevant units about the work flow. This method effectively shortens the work flow of online certifications of vendors and commodities. The work flows of the vendor online certification and commodity online certification are described separately in the following paragraphs.

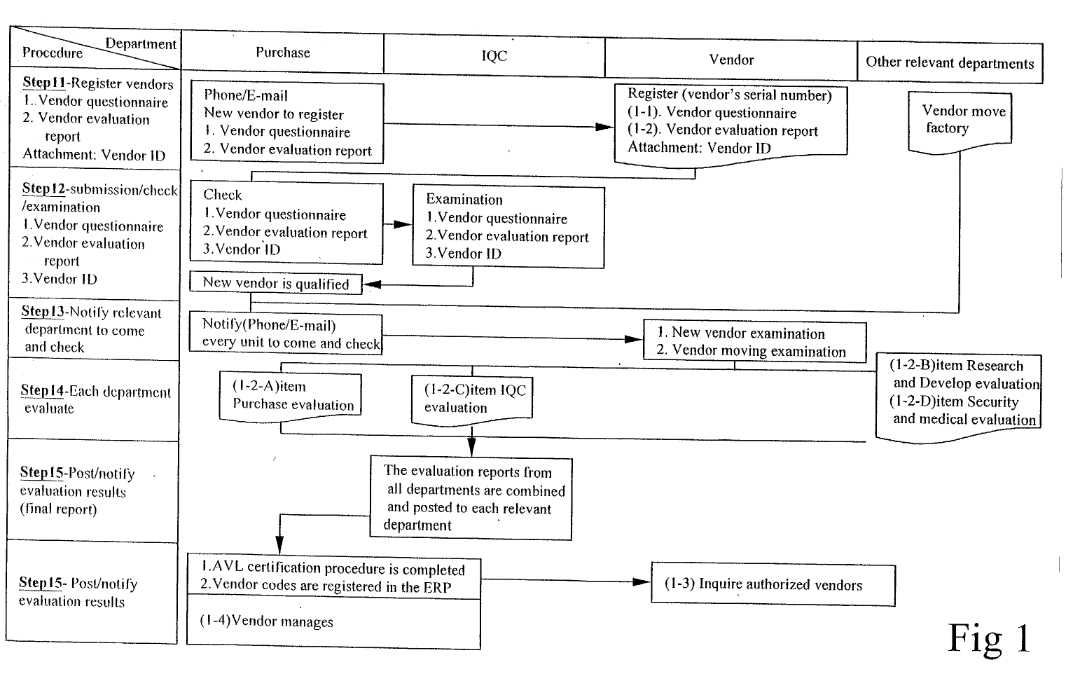

As shown in FIG. 1, the invention provides a trading web site for executing a BP (Business Process) for vendor certification. The exchanged messages use EDI as the transmission protocol. The work flow includes five steps:

Step 11: Perform a vendor registration procedure. This step requires a vendor questionnaire and a vendor evaluation report (the attachment includes a vendor ID). In this step, a purchase department asks by phone/E-mail a new vendor to provide the vendor questionnaire and the vendor evaluation report. After the vendor receives the notice from the purchase department, it enters the trading web site to register the vendor's serial number and to have the vendor questionnaire and the vendor evaluation report ready for examination.

Step 12: Perform a submission/check/examination procedure. This step includes submitting/checking/examining the vendor questionnaire and the vendor evaluation report (the attachment includes a vendor ID). In this step, the purchase department performs checks according to the information provided by the vendor. Then the IQC department performs checks and replies whether the new vendor registered by the purchase department is qualified.

Step 13: Notify relevant department to come and check. The purchase department notifies (by phone/E-mail) every unit to come and check. The vendor check includes a new vendor examination and a vendor moving examination.

Step 14: Each department performs evaluations. The purchase department, IQC department and other relevant departments (the research department, security and medical department) perform relevant evaluations according to the vendor's evaluation report.

Step 15: Post/notify evaluation results (final report). The evaluation reports from all departments are combined and posted to each relevant department. Now, an AVL (Authorized Vendor List) certification procedure is completed. Vendor codes are registered in the ERP (Enterprise Resource Planning) for vendors to inquire authorized vendors. At the same time, the purchase department organizes and manages the authorized vendors.

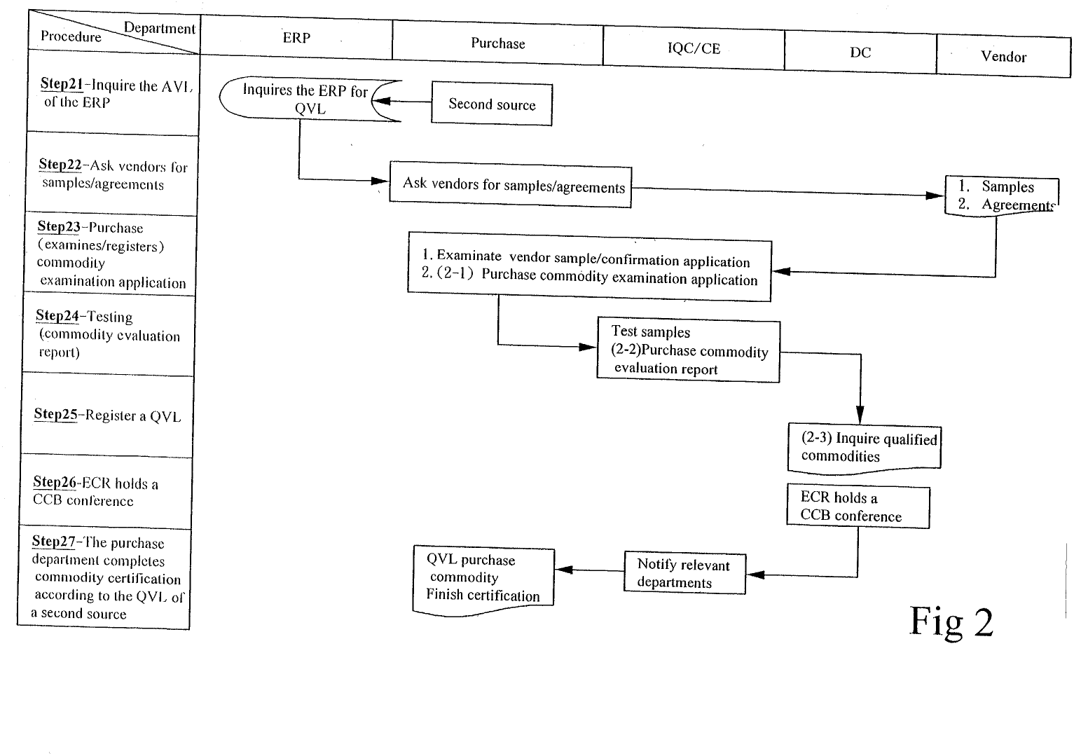

With reference to FIG. 2, the BP for commodity certification is performed according to the AVL. The message exchanges still use EDI as the transmission protocol. This work flow includes seven steps.

Step 21: Inquire the AVL of the ERP. The purchase department inquires the ERP for a QVL (Qualified Vendor List) according to a second source. The second source has reserve vendors that provide same materials for emergent shipping.

Step 22: Ask vendors for samples/agreements. The purchase selects a vendor and asks the vendor to send a sample/agreement/commodity examination application.

Step 23: The purchase department examines/registers a commodity examination application. After receiving a sample/confirmation/commodity examination application request, the vendor sends it to the purchase department for the examination of the sample/confirmation/commodity examination application.

Step 24: Perform tests (commodity evaluation report). An IQC/CE department is notified to test samples of the commodities checked by the purchase department and generates a commodity evaluation report.

Step 25: Register and inquire a QVL (Qualified Vendor List). According to the commodity evaluation report produced from the sample tests performed by the IQC/CE department, qualified commodities are registered at the trading web site for a DC (Document Center) department's inquiry.

Step 26: ECR holds a CCB conference. The DC department inquires about the qualified commodities and the ECR starts a CCB conference, determining the procedure of commodity certification.

Step 27: The purchase department finishes the commodity certification according to the QVL of a second source. The IQC/CE department notifies relevant departments and the purchase department to purchase the commodities.

What is claimed is:

1. An online certification method with quality assurance, which provides a manufacturer a BP (Business Process) for certification of a plurality of vendors on a trading web site with messages exchanged using EDI as a transmission protocol, comprising the steps of:
notifying a vendor to register through a purchase department and sending data of a vendor to the trading web site;
the purchase department checking the vendor data provided by the vendor;
an IQC department examining the vendor data and returning an AVL (Authorized Vendor List) registered by the purchase department;
the purchasing department notifying each unit to go to the vendor on the AVL for checking; and
organizing evaluation reports from each unit, determining the AVL, and posting the AVL on the trading web site to each unit.

2. The method of claim 1, wherein the vendors include new vendors and vendors that moved their factories.

3. The method of claim 1, wherein the vendor data include a vendor questionnaire, a vendor evaluation report and a vendor ID (Identification).

4. The method of claim 1, wherein the units include a purchase department, an IQC department, a research department, and a security and medical department.

5. The method of claim 1 further comprising the step of registering the AVL in an ERP (Enterprise Resource Planning).

6. The method of claim 1, wherein the AVL is managed by the purchase department.

7. An online certification method with quality assurance, which provides a manufacturer a BP (Business Process) for certification of a plurality of commodities on a trading web site with messages exchanged using EDI as a transmission protocol, comprising the steps of:
a purchase department inquiring a QVL (Qualified Vendor List) from an ERP according to a second source;
the purchase department selecting at least one vendor and asking the vendor to provide a sample/confirmation/commodity examination application;
the purchase department examining the sample/confirmation/commodity examination application;
notifying an IQC/CE department to test samples of the commodities examined by the purchase department and generating a commodity evaluation report;
the IQC/CE department determining a QVL according to the commodity evaluation report and registering the QVL at a trading web site; and
the IQC/CE department posting information to relevant departments and notifying the purchase department to complete the commodity certification procedure.

8. The method of claim 7, wherein the second source is a reserve vendor which provides same materials for emergent shipping.

9. The method of claim 7, wherein the step of registering the QVL at a trading web site allows a DC (Document Center) department to inquire about the qualified commodities.

10. The method of claim 7 further comprising a procedure of holding a CCB (Change Control Board) conference by an ECR (Engineering Change Require) for the commodity certification.
